(19) United States
(12) Patent Application Publication
(10) Pub. No.: US 2022/0078457 A1
(43) Pub. Date: Mar. 10, 2022

(54) SYSTEMS, METHODS, AND ARTICLES FOR ADAPTIVE LOSSY DECODING

(71) Applicant: REALNETWORKS, INC., Seattle, WA (US)

(72) Inventors: Le SHI, Beijing (CN); Chia-Yang TSAI, Bellevue, WA (US)

(21) Appl. No.: 17/419,667

(22) PCT Filed: Jan. 2, 2019
(86) PCT No.: PCT/US2019/012091

§ 371 Date: Jun. 29, 2021

(51) Int. Cl. H04N 19/44; H04N 19/154; H04N 19/12; H04N 19/117; H04N 19/82

(52) U.S. Cl. CPC H04N 19/44; H04N 19/154; H04N 19/82; H04N 19/117; H04N 19/12

(57) ABSTRACT

Systems, methods, and articles that improve video playback on various devices by dynamically modifying the operation of a video decoder. The operation of a video decoder is dynamically simplified under certain conditions during video playback to provide higher decoding speeds that require less computing resources. A lossy control module is provided in the decoder that is operative to select different lossy decode levels to be used by the decoder at various detected operating conditions so that the decoding of a video can be dynamically sped up during playback of the video, thereby reducing or eliminating jittering or delayed playback

### BACKGROUND

### Technical Field

The present disclosure generally relates to video processing, and more particularly, to video decoding systems and methods.

### Description of the Related Art

The advent of digital multimedia such as digital images, speech/audio, graphics, and video have significantly improved various applications as well as opened up brand new applications due to relative ease by which it has enabled reliable storage, communication, transmission, and, search and access of content. Overall, the applications of digital multimedia have been many, encompassing a wide spectrum including entertainment, information, medicine, and security, and have benefited the society in numerous ways. Multimedia as captured by sensors such as cameras and microphones is often analog, and the process of digitization in the form of Pulse Coded Modulation (PCM) renders it digital. However, just after digitization, the amount of resulting data can be quite significant as is necessary to re-create the analog representation needed by speakers and/or TV display. Thus, efficient communication, storage or transmission of the large volume of digital multimedia content requires its compression from raw PCM form to a compressed representation. Thus, many techniques for compression of multimedia have been invented. Over the years, video compression techniques have grown very sophisticated to the point that they can often achieve high compression factors between 10 and 100 while retaining high psycho-visual quality, often similar to uncompressed digital video.

While tremendous progress has been made to date in the art and science of video compression (as exhibited by the plethora of standards bodies driven video coding standards such as MPEG-1, MPEG-2, H.263, MPEG-4 part2, MPEG-4 AVC/H.264, HEVC, AV1, MPEG-4 SVC and MVC, as well as industry driven proprietary standards such as Windows Media Video, RealVideo, On2 VP, and the like), the ever increasing appetite of consumers for even higher quality, higher definition, and now 3D (stereo) video, available for access whenever, wherever, has necessitated delivery via various means such as DVD/BD, over the air broadcast, cable/satellite, wired and mobile networks, to a range of client devices such as PCs/laptops, TVs, set top boxes, gaming consoles, portable media players/devices, smartphones, and wearable computing devices, fueling the desire for even higher levels of video compression. In the standards-body-driven standards, this is evidenced by the recently started effort by ISO MPEG in High Efficiency Video coding which is expected to combine new technology contributions and technology from a number of years of exploratory work on H.265 video compression by ITU-T standards committee.

All aforementioned standards employ a general intra/interframe predictive coding framework in order to reduce spatial and temporal redundancy in the encoded bitstream. The basic concept of interframe prediction is to remove the temporal dependencies between neighboring pictures by using block matching method. At the outset of an encoding process, each frame of the unencoded video sequence is grouped into one of three categories: I-type frames, P-type frames, and B-type frames. I-type frames are intra-coded. That is, only information from the frame itself is used to encode the picture and no inter-frame motion compensation techniques are used (although intra-frame motion compensation techniques may be applied).

The other two types of frames, P-type and B-type, are encoded using inter-frame motion compensation techniques. The difference between P-picture and B-picture is the temporal direction of the reference pictures used for motion compensation. P-type pictures utilize information from previous pictures in display order, whereas B-type pictures may utilize information from both previous and future pictures in display order.

For P-type and B-type frames, each frame is then divided into blocks of pixels, represented by coefficients of each pixel's luma and chrominance components, and one or more motion vectors are obtained for each block (because B-type pictures may utilize information from both a future and a past displayed frame, two motion vectors may be encoded for each block). A motion vector (MV) represents the spatial displacement from the position of the current block to the position of a similar block in another, previously encoded frame (which may be a past or future frame in display order), respectively referred to as a reference block and a reference frame. The difference between the reference block and the current block is calculated to generate a residual (also referred to as a “residual signal”). Therefore, for each block of an inter-coded frame, only the residuals and motion vectors need to be encoded rather than the entire contents of the block. By removing this kind of temporal redundancy between frames of a video sequence, the video sequence can be compressed.

To further compress the video data, after inter or intra frame prediction techniques have been applied, the coefficients of the residual signal are often transformed from the spatial domain to the frequency domain (e.g. using a discrete cosine transform (“DCT”) or a discrete sine transform (“DST”)). For naturally occurring images, such as the type of images that typically make up human perceptible video sequences, low-frequency energy is always stronger than high-frequency energy. Residual signals in the frequency domain therefore get better energy compaction than they would in spatial domain. After forward transform, the coefficients and motion vectors may be quantized and entropy encoded.

On the video decoder side, inversed quantization and inversed transforms are applied to recover the spatial residual signal. These are typical transform/quantization processes in all video compression standards. A reverse prediction process may then be performed in order to generate a recreated version of the original unencoded video sequence. Generally, all of the compression tools on the decoder side are normative and part of the encoding loop. Thus, the output or “output frame” of the decoder is identical to a “reconstruct frame” generated by an encoder. Any changes to the decoder may cause quality degradation and a mismatch between the output frame of the decoder and the reconstruct frame of the encoder.

In past standards, the blocks used in coding were generally sixteen by sixteen pixels (referred to as macroblocks in many video coding standards). However, since the development of these standards, frame sizes have grown larger and many devices have gained the capability to display higher than “high definition” (or “HD”) frame sizes, such as 1920×1080 pixels. Thus it may be desirable to have larger blocks to efficiently encode the motion vectors for these frame size, e.g. 64×64 pixels. However, because of the corresponding increases in resolution, it also may be desirable to be able to perform motion prediction and transformation on a relatively small scale, e.g. 4×4 pixels.

### BRIEF SUMMARY

A video decoder operative to decode video data may be summarized as including at least one nontransitory processor-readable storage medium that stores at least one of processor-executable instructions or data; and control circuitry communicatively coupled to the at least one nontransitory processor-readable storage medium, in operation, the control circuitry decodes a bitstream of video data according to one of a plurality of lossy decoding levels of the video decoder, each of the plurality of lossy decoding levels providing different levels of performance for the video decoder; and iteratively during decoding of the bitstream of video data, receives condition information relating to at least one of: a performance condition of the video decoder, or an operational condition of a device communicatively coupled to the video decoder; selects one of the plurality of lossy decoding levels based at least in part on the received condition information; configures the video decoder to decode video data according to the selected lossy decoding level; and decodes the bitstream of video data at the selected lossy decoding level of the video decoder. At least one of the plurality of selectable lossy decoding levels may provide lossless decoding. The video decoder may include a deblock filter, and to configure the video decoder to decode video data according to the selected lossy decoding level, the control circuitry may modify operation of the deblock filter of the video decoder. To configure the video decoder to decode video data according to the selected lossy decoding level, the control circuitry may at least one of weaken or disable operation of the deblock filter of the video decoder.

To configure the video decoder to decode video data according to the selected lossy decoding level, the control circuitry may at least one of enable the deblock filter for all frames; disable the deblock filter for referenced frames or non-referenced frames; adjust a strength of the deblock filter; or disable the deblock filter. The video decoder may include a motion compensator, and to configure the video decoder to decode video data according to the selected lossy decoding level, the control circuitry may modify operation of the motion compensator of the video decoder. To configure the video decoder to decode video data according to the selected lossy decoding level, the control circuitry may at least one of weaken or disable operation of the motion compensator of the video decoder.

To configure the video decoder to decode video data according to the selected lossy decoding level, the control circuitry may at least one of enable full-precision fractional motion compensation by the motion compensator; enable low-precision motion compensation by the motion compensator; or disable the motion compensator. The video decoder may include a deblock filter and a motion compensator, and to configure the video decoder to decode video data according to the selected lossy decoding level, the control circuitry may modify operation of at least one of the deblock filter or the motion compensator of the video decoder. To configure the video decoder to decode video data according to the selected lossy decoding level, the control circuitry may at least one of weaken or disable operation of at least one of the deblock filter or the motion compensator of the video decoder.

The plurality of selectable lossy decoding levels may include a first lossy decoding level which provides lossless decoding; a second lossy decoding level in which the deblock filter is weakened or disabled for non-referenced frames only; a third lossy decoding level in which the deblock filter is weakened or disabled for inter-referenced frames and non-referenced frames; and a fourth lossy decoding level in which the deblock filter is weakened or disabled for all frames, and the motion compensator is configured to provide low-precision motion compensation for non-referenced frames. The received condition information may include at least one of a difference between an audio timestamp and a video timestamp of the video data, or a buffer fullness level of a video display buffer. The received condition information may include at least one of: CPU loading information or battery life information for a battery of the device communicatively coupled to the video decoder.

A video decoding method to decode video data may be summarized as including decoding a bitstream of video data according to one of a plurality of lossy decoding levels of a video decoder, each of the plurality of lossy decoding levels providing different levels of performance for the video decoder; and iteratively during decoding of the bitstream of video data, receiving condition information relating to at least one of: a performance condition of the video decoder, or an operational condition of a device communicatively coupled to the video decoder; selecting one of the plurality of lossy decoding levels based at least in part on the received condition information; configuring the video decoder to decode video data according to the selected lossy decoding level; and decoding the bitstream of video data at the selected lossy decoding level of the video decoder. Selecting one of the plurality of lossy decoding levels may include selecting one of the plurality of lossy decoding levels, at least one of which may provide lossless decoding. The video decoder may include a deblock filter, configuring the video decoder to decode video data according to the selected lossy decoding level may include modifying operation of the deblock filter of the video decoder. Configuring the video decoder to decode video data according to the selected lossy decoding level may include at least one of weakening or disabling operation of the deblock filter of the video decoder.

Configuring the video decoder to decode video data according to the selected lossy decoding level may include at least one of enabling the deblock filter for all frames; disabling the deblock filter for referenced frames or non-referenced frames; adjusting a strength of the deblock filter; or disabling the deblock filter. The video decoder may include a motion compensator, and configuring the video decoder to decode video data according to the selected lossy decoding level may include modifying operation of the motion compensator of the video decoder. Configuring the video decoder to decode video data according to the selected lossy decoding level may include at least one of weakening or disabling operation of the motion compensator of the video decoder. Configuring the video decoder to decode video data according to the selected lossy decoding level may include at least one of enabling full-precision fractional motion compensation by the motion compensator; enabling low-precision motion compensation by the motion compensator; or disabling the motion compensator.

The video decoder may include a deblock filter and a motion compensator, and configuring the video decoder to decode video data according to the selected lossy decoding level may include modifying operation of at least one of the deblock filter or the motion compensator of the video decoder. Configuring the video decoder to decode video data according to the selected lossy decoding level may include at least one of weakening or disabling operation of at least one of the deblock filter or the motion compensator of the video decoder.

Selecting one of the plurality of lossy decoding levels may include selecting one of a first lossy decoding level which may provide lossless decoding; a second lossy decoding level in which the deblock filter may be weakened or disabled for non-referenced frames only; a third lossy decoding level in which the deblock filter may be weakened or disabled for inter-referenced frames and non-referenced frames; and a fourth lossy decoding level in which the deblock filter may be weakened or disabled for all frames, and the motion compensator may be configured to provide low-precision motion compensation for non-referenced frames. Receiving condition information may include receiving at least one of a difference between an audio timestamp and a video timestamp of the video data, or a buffer fullness level of a video display buffer. Receiving condition information may include receiving at least one of CPU loading information or battery life information for a battery of the device communicatively coupled to the video decoder.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 illustrates an exemplary video encoding/decoding system, according to one non-limiting illustrated implementation.

FIG. 2 illustrates several components of an exemplary encoding device, according to one non-limiting illustrated implementation.

FIG. 3 illustrates several components of an exemplary decoding device, according to one non-limiting illustrated implementation.

FIG. 4 illustrates a block diagram of an exemplary video encoder, according to one non-limiting illustrated implementation.

FIG. 5 illustrates a block diagram of an exemplary video decoder, according to one non-limiting illustrated implementation.

FIG. 6 illustrates a schematic diagram of video and audio timing and a video display buffer, according to one non-limiting illustrated implementation.

FIG. 7 illustrates a flow diagram for a method of operating a video decoder to decode video data with adaptive lossy decoding, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

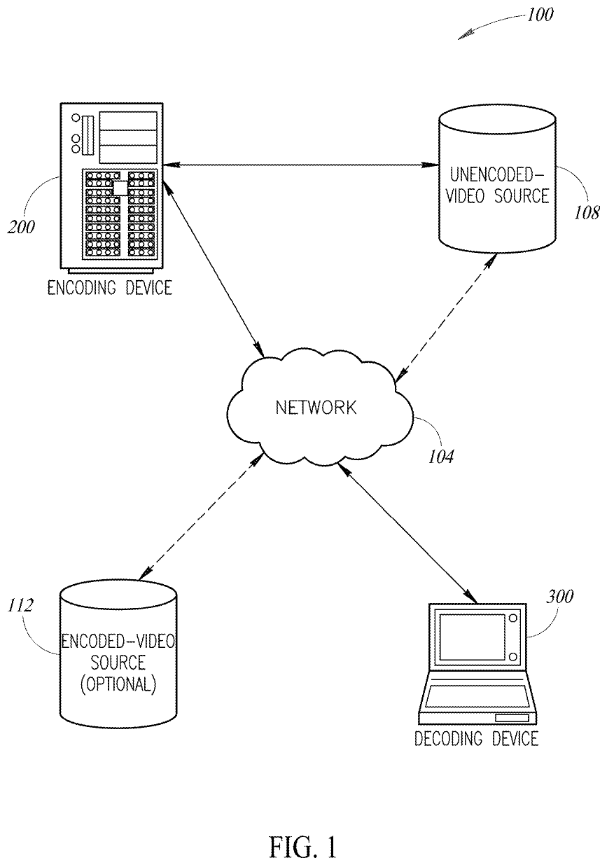

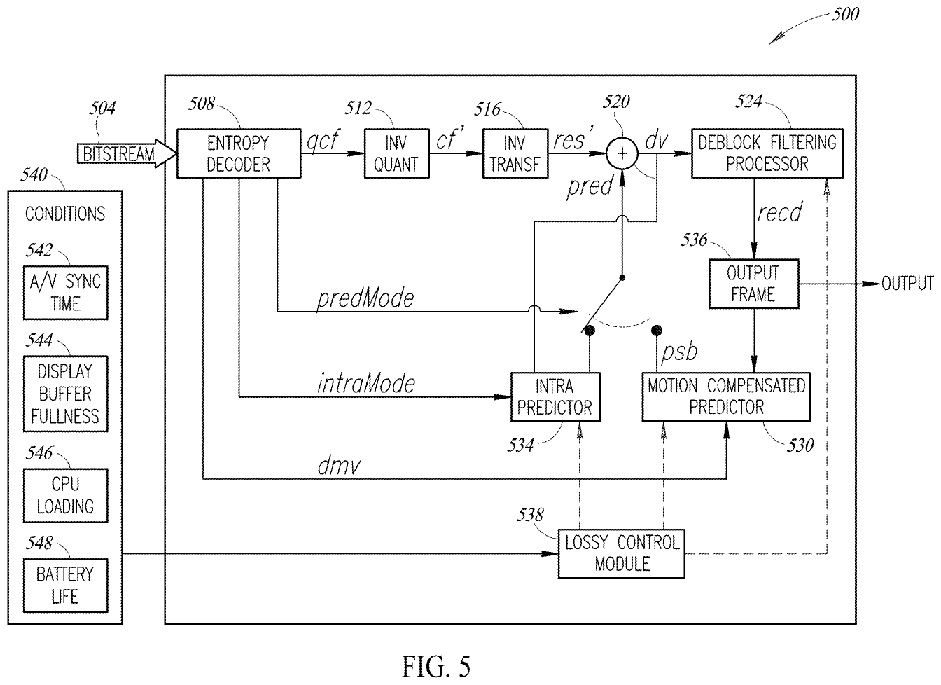

One or more implementations of the present disclosure are directed to systems, methods, and articles that improve video playback on various devices (e.g., smartphones, tablets, laptops, desktop computers, smart TVs) by adaptively of dynamically modifying the operation of a video decoder during playback (rendering). Decoding speed may be significantly related to user experience during the playback of a video, especially on mobile devices or any device with potentially limited processing capabilities, for example. Low decoding speed by a device can cause undesirable effects, such as playback jittering or delay. In at least some implementations discussed herein, the decoding process is dynamically simplified under certain conditions to provide higher decoding speeds and reduced computing requirements. In order to control the quality degradation resulting from altering the decoding process, “adaptive lossy decoding” is provided. As discussed further with reference to FIG. 5, a “lossy control” module is provided in the decoder that is operative to select different lossy decode levels to be used by the decoder at various conditions so that the decoding of a video can be dynamically sped up during playback of the video. Using the techniques discussed herein, the quality degradation due to the dynamically simplified decode process is acceptable as a tradeoff to the undesirable effects caused by slow decoding speed, such as jittering or delayed playback. The various features of the implementations of the present disclosure are discussed below with reference to FIGS. 1-7.

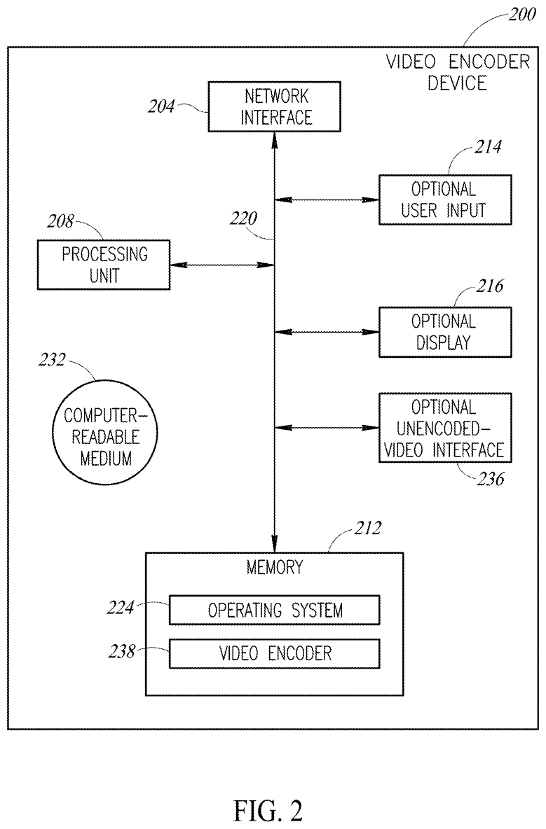

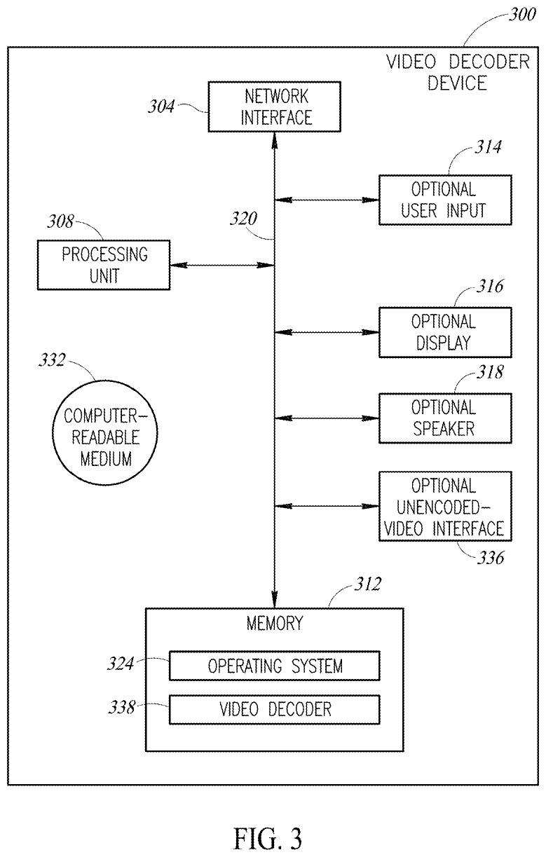

FIG. 1 illustrates an exemplary video encoding/decoding system 100 in accordance with at least one embodiment. Encoding device 200 (illustrated in FIG. 2 and described below) and decoding device 300 (illustrated in FIG. 3 and described below) are in data communication with a network 104. Encoding device 200 may be in data communication with unencoded video source 108, either through a direct data connection such as a storage area network (“SAN”), a high speed serial bus, and/or via other suitable communication technology, or via network 104 (as indicated by dashed lines in FIG. 1). Similarly, decoding device 300 may be in data communication with an optional encoded video source 112, either through a direct data connection, such as a storage area network (“SAN”), a high speed serial bus, and/or via other suitable communication technology, or via network 104 (as indicated by dashed lines in FIG. 1). In some embodiments, encoding device 200, decoding device 300, encoded-video source 112, and/or unencoded-video source 108 may comprise one or more replicated and/or distributed physical or logical devices. In many embodiments, there may be more encoding devices 200, decoding devices 300, unencoded-video sources 108, and/or encoded-video sources 112 than are illustrated.

In various embodiments, encoding device 200, may be a networked computing device generally capable of accepting requests over network 104, e.g., from decoding device 300, and providing responses accordingly. In various embodiments, decoding device 300 may be a networked computing device having a form factor such as a mobile phone; a watch, glass, or other wearable computing device; a dedicated media player; a computing tablet; a motor vehicle head unit; an audio-video on demand (AVOD) system; a dedicated media console; a gaming device, a “set-top box,” a digital video recorder, a television, or a general purpose computer. In various embodiments, network 104 may include the Internet, one or more local area networks (“LANs”), one or more wide area networks (“WANs”), cellular data networks, and/or other data networks. Network 104 may, at various points, be a wired and/or wireless network.

Referring to FIG. 2, several components of an exemplary encoding device 200 are illustrated. In some embodiments, an encoding device may include fewer or more components than those shown in FIG. 2. However, it is not necessary that all of these generally conventional components be shown in order to disclose an illustrative embodiment. As shown in FIG. 2, exemplary encoding device 200 includes a network interface 204 for connecting to a network, such as network 104. Exemplary encoding device 200 also includes a processing unit 208, a memory 212, an optional user input 214 (e.g. an alphanumeric keyboard, keypad, a mouse or other pointing device, a touchscreen, and/or a microphone), and an optional display 216, all interconnected along with the network interface 204 via a bus 220. The memory 212 generally comprises a RAM, a ROM, and/or a permanent mass storage device, such as a disk drive, flash memory, or the like.

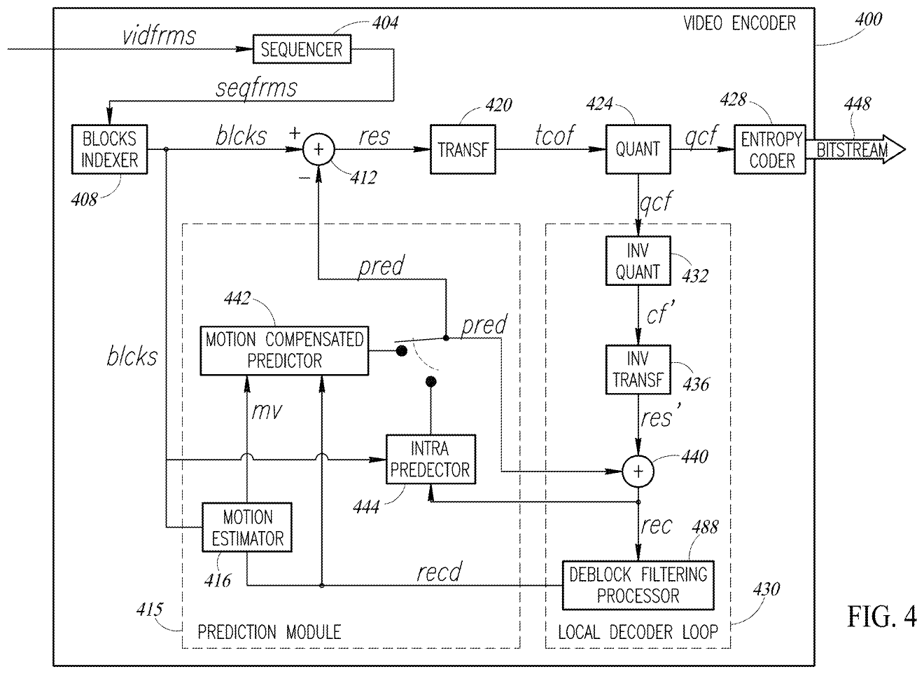

The memory 212 of exemplary encoding device 200 stores an operating system 224 as well as program code for a number of software services, such as a video encoder 238 (described below in reference to video encoder 400 of FIG. 4). Memory 212 may also store video data files (not shown) which may represent unencoded copies of audio/visual media works, such as, by way of examples, movies and/or television episodes. These and other software components may be loaded into memory 212 of encoding device 200 using a drive mechanism (not shown) associated with a non-transitory computer-readable medium 232, such as a floppy disc, tape, DVD/CD-ROM drive, memory card, or the like. Although an exemplary encoding device 200 has been described, an encoding device may be any of a great number of networked computing devices capable of communicating with network 104 and executing instructions for implementing video encoding software, such as exemplary video encoder 238 or video encoder 400 of FIG. 4.

In operation, the operating system 224 manages the hardware and other software resources of the encoding device 200 and provides common services for software applications, such as video encoder 238. For hardware functions such as network communications via network interface 204, receiving data via input 214, outputting data via display 216, and allocation of memory 212 for various software applications, such as video encoder 238, operating system 224 acts as an intermediary between software executing on the encoding device and the hardware.

In some embodiments, encoding device 200 may further comprise a specialized unencoded video interface 236 for communicating with unencoded-video source 108 (FIG. 1), such as a high speed serial bus, or the like. In some embodiments, encoding device 200 may communicate with unencoded-video source 108 via network interface 204. In other embodiments, unencoded-video source 108 may reside in memory 212 or computer readable medium 232.

Although an exemplary encoding device 200 has been described that generally conforms to conventional general purpose computing devices, an encoding device 200 may be any of a number of devices capable of encoding video, for example, a video recording device, a video co-processor and/or accelerator, a personal computer, a game console, a set-top box, a handheld or wearable computing device, a smart phone, or any other suitable device.

Encoding device 200 may, by way of example, be operated in furtherance of an on-demand media service (not shown). In at least one exemplary embodiment, the on-demand media service may be operating encoding device 200 in furtherance of an online on-demand media store providing digital copies of media works, such as video content, to users on a per-work and/or subscription basis. The on-demand media service may obtain digital copies of such media works from unencoded video source 108.

Referring to FIG. 3, several components of an exemplary decoding device 300 are illustrated. In some embodiments, a decoding device may include fewer or more components than those shown in FIG. 3. However, it is not necessary that all of these generally conventional components be shown in order to disclose an illustrative embodiment. As shown in FIG. 3, exemplary decoding device 300 includes a network interface 304 for connecting to a network, such as network 104. Exemplary decoding device 300 also includes a processing unit 308, a memory 312, an optional user input 314 (e.g. an alphanumeric keyboard, keypad, a mouse or other pointing device, a touchscreen, and/or a microphone), an optional display 316, and an optional speaker 318, all interconnected along with the network interface 304 via a bus 320. The memory 312 generally comprises a RAM, a ROM, and a permanent mass storage device, such as a disk drive, flash memory, or the like.

The memory 312 of exemplary decoding device 300 may store an operating system 324 as well as program code for a number of software services, such as video decoder 338 (described below in reference to video decoder 500 of FIG. 5). Memory 312 may also store video data files (not shown) which may represent encoded copies of audio/visual media works, such as, by way of example, movies and/or television episodes. These and other software components may be loaded into memory 312 of decoding device 300 using a drive mechanism (not shown) associated with a non-transitory computer-readable medium 332, such as a floppy disc, tape, DVD/CD-ROM drive, memory card, or the like. Although an exemplary decoding device 300 has been described, a decoding device may be any of a great number of networked computing devices capable of communicating with a network, such as network 104, and executing instructions for implementing video decoding software, such as video decoder 338.

In operation, the operating system 324 manages the hardware and other software resources of the decoding device 300 and provides common services for software applications, such as video decoder 338. For hardware functions such as network communications via network interface 304, receiving data via input 314, outputting data via display 316 and/or optional speaker 318, and allocation of memory 312, operating system 324 acts as an intermediary between software executing on the encoding device and the hardware.

In some embodiments, the decoding device 300 may further comprise an optional encoded video interface 336, e.g., for communicating with encoded-video source 112, such as a high speed serial bus, or the like. In some embodiments, decoding device 300 may communicate with an encoded-video source, such as encoded video source 112, via network interface 304. In other embodiments, encoded-video source 112 may reside in memory 312 or computer readable medium 332.

Although an exemplary decoding device 300 has been described that generally conforms to conventional general purpose computing devices, an decoding device 300 may be any of a great number of devices capable of decoding video, for example, a video recording device, a video co-processor and/or accelerator, a personal computer, a game console, a set-top box, a handheld or wearable computing device, a smart phone, or any other suitable device.

Decoding device 300 may, by way of example, be operated in furtherance of an on-demand media service. In at least one exemplary embodiment, the on-demand media service may provide digital copies of media works, such as video content, to a user operating decoding device 300 on a per-work and/or subscription basis. The decoding device may obtain digital copies of such media works from unencoded video source 108 via, for example, encoding device 200 via network 104.

FIG. 4 shows a general functional block diagram of software implemented video encoder 400 (hereafter “encoder 400”) employing residual transformation techniques in accordance with at least one embodiment. The video encoder 400 may be similar or identical to the video encoder 238 of the encoding device 200 shown in FIG. 2. One or more unencoded video frames (vidfrms) of a video sequence in display order may be provided to sequencer 404.

Sequencer 404 may assign a predictive-coding picture-type (e.g. I, P, or B) to each unencoded video frame and reorder the sequence of frames, or groups of frames from the sequence of frames, into a coding order for motion prediction purposes (e.g. I-type frames followed by P-type frames, followed by B-type frames). The sequenced unencoded video frames (seqfrms) may then be input in coding order to blocks indexer 408.

For each of the sequenced unencoded video frames (seqfrms), blocks indexer 408 may determine a largest coding block (“LCB”) size for the current frame (e.g. sixty-four by sixty-four pixels) and divide the unencoded frame into an array of coding blocks (blcks). Individual coding blocks within a given frame may vary in size, e.g. from four by four pixels up to the LCB size for the current frame.

Each coding block may then be input one at a time to differencer 412 and may be differenced with corresponding prediction signal blocks (pred) generated in a prediction module 415 from previously encoded coding blocks. To generate the prediction blocks (pred), coding blocks (blcks) are also provided to an intra-predictor 444 and a motion estimator 416 of the prediction module 415. After differencing at differencer 412, a resulting residual block (res) may be forward-transformed to a frequency-domain representation by transformer 420, resulting in a block of transform coefficients (tcof). The block of transform coefficients (tcof) may then be sent to a quantizer 424 resulting in a block of quantized coefficients (gcf) that may then be sent both to an entropy coder 428 and to a local decoder loop 430.

For intra-coded coding blocks, intra-predictor 444 provides a prediction signal representing a previously coded area of the same frame as the current coding block. For an inter-coded coding block, motion compensated predictor 442 provides a prediction signal representing a previously coded area of a different frame from the current coding block.

At the beginning of local decoding loop 430, inverse quantizer 432 may de-quantize the block of transform coefficients (cf′) and pass them to inverse transformer 436 to generate a de-quantized residual block (res′). At adder 440, a prediction block (pred) from motion compensated predictor 442 or intra predictor 444 may be added to the de-quantized residual block (res′) to generate a locally decoded block (rec). Locally decoded block (rec) may then be sent to a frame assembler and deblock filter processor 488, which reduces blockiness and assembles a recovered or reconstructed frame (recd), which may be used as the reference frame for motion estimator 416 and motion compensated predictor 442.

Entropy coder 428 encodes the quantized transform coefficients (gcf), differential motion vectors (dmv), and other data, generating an encoded video bit-stream 448. For each frame of the unencoded video sequence, encoded video bit-stream 448 may include encoded picture data (e.g. the encoded quantized transform coefficients (gcf) and differential motion vectors (dmv)) and an encoded frame header (e.g. syntax information such as the LCB size for the current frame).

FIG. 5 shows a general functional block diagram of a corresponding video decoder 500 (hereafter “decoder 500”) that implements inverse residual transformation techniques in accordance with at least one embodiment and that is suitable for use with a decoding device, such as decoding device 300. Decoder 500 may work similarly to the local decoding loop 430 of encoder 400 discussed above.

Specifically, an encoded video bit-stream 504 to be decoded may be provided to an entropy decoder 508, which may decode blocks of quantized coefficients (gcf), differential motion vectors (dmv), accompanying message data packets (msg-data), and other data, including the prediction mode (intra or inter). The quantized coefficient blocks (gel) may then be reorganized by an inverse quantizer 512, resulting in recovered transform coefficient blocks (cf′). Recovered transform coefficient blocks (cf′) may then be inverse transformed out of the frequency-domain by an inverse transformer 516, resulting in decoded residual blocks (res′).

When the prediction mode for a current block is the inter prediction mode, an adder 520 may add motion compensated prediction blocks (psb) obtained by using corresponding motion vectors (dmv) from a motion compensated predictor 530.

When the prediction mode for a current block is the intra prediction mode, a predicted block may be constructed on the basis of pixel information of a current picture. At this time, the intra predictor 534 may determine an intra prediction mode of the current block and may perform the prediction on the basis of the determined intra prediction mode. Here, when intra prediction mode-relevant information received from the video encoder is confirmed, the intra prediction mode may be induced to correspond to the intra prediction mode-relevant information.

The resulting decoded video (dv) may be deblock-filtered in a frame assembler and deblock filtering processor 524 (or “deblock filter”). Blocks (recd) at the output of frame assembler and deblock filtering processor 524 form a reconstructed or output frame 536 of the video sequence, which may be output from the video decoder 500 and also may be used as the reference frame for the motion compensated predictor 530 for decoding subsequent coding blocks.

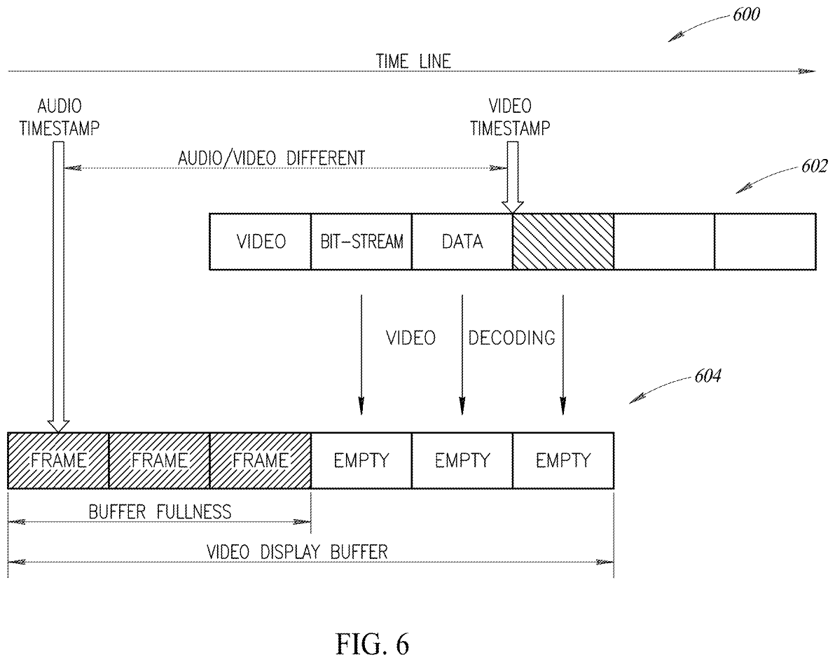

FIG. 6 is a schematic diagram 600 that illustrates an example processing flow for video decoding of video bitstream data 602 and display or rendering via a video display buffer 604. The video decoder (e.g., decoder 500) decodes compressed symbols to frame data comprising reconstructed pixels. Each pixel may be represented by an N-bit sample (e.g., 8-bit sample, 10-bit sample, 12-bit sample, 16-bit sample). Every decoded frame is sent to the video display buffer 604 before playback (rendering). Usually, a video playback timestamp is synchronized with an audio playback timestamp. Because video decoding is much more complicated than audio decoding, video decoding is always in front of audio decoding. For example, if the progress of current playback is at the 10 second bitstream position, the video decoding may be ahead (e.g., at the 15 second bitstream position). The decoded but not yet rendered frames are stored in the video display buffer 604. The decoding time of each video frame can vary substantially. Thus, using the video display buffer 604 effectively absorbs the longer decoding times so that the playback will be smooth.

Based on the above, the difference between the audio timestamp and the video timestamp, also referred to herein as “audio/video sync time” or “A/V sync time,” may provide a good metric to evaluate the decoding capability of the device (e.g., smartphone) that implements the decoder. For example, if the time stamp difference is large, the playback is usually smooth because the decoder is able to keep up with the playback speed. Conversely, if the time stamp difference is small, jittering or playback delay is expected since the decoder cannot keep up with the playback speed.

Referring back to FIG. 5, the decoder 500 includes a lossy control module 538 that is operatively coupled to the intra-predictor 534, the motion compensated predictor 530, and the deblock filter 524. The lossy control module 538 is also communicatively coupled to receive various conditions 540, which may be device related conditions, decoder related conditions, etc. In the illustrated implementation, non-limiting examples of conditions include A/V sync time 542, display buffer fullness 544, CPU loading 546, and device battery life 548. It should be appreciated that in other implementations fewer or more conditions may be used by the lossy control module 538 to adaptively control the performance of the decoder 500.

According to one or more implementations, the lossy control module 538 may adaptively select one of a plurality of lossy decoding levels by periodically checking the A/V sync time 542 (e.g., the difference between the audio track and the video track) and the fullness 544 of the video display buffer (e.g., display buffer 604 of FIG. 6). The lossy control module 538 may check or receive these conditions iteratively at regular or irregular intervals during a decoding and playback process. For example, the lossy control module 538 may check the conditions every 1 second, every 2 seconds, every 5 seconds, every 30 seconds, etc.

In one non-limiting example, the lossy control module 538 may dynamically select one of four different lossy decode levels L0, L1, L2, and L3. Lossy decode level L0 may provide lossless decoding, lossy decode level L1 may provide mild lossy decoding, lossy decode level L2 may provide moderate lossy decoding, and lossy decode level L3 may provide severe lossy decoding. Lossy decode level L0 may provide the best quality but requires the most processing time and resources to implement, and lossy decode level L3 may provide the relatively degraded quality but requires the least processing time and resources to implement.

As a non-limiting example, in at least some implementations if there is no delay in the video playback and the decoding speed is fast, the lossy decode module 538 may select lossy decode level L0, wherein the video quality at the output frame 536 is identical to that at the reconstruct frame of the encoder. For instance, lossy decode level L0 may be selected if the A/V sync time 542 is greater than 200 milliseconds (ms) and the display buffer fullness 544 is greater than 70% full. If there is no delay in the video playback and the decoding speed is normal, the lossy decode module 538 may select lossy decode level L1, wherein the video quality at the output frame 536 is mildly worse than that at the reconstruct frame of the encoder. For instance, lossy decode level L1 may be selected if the A/V sync time 542 is less than 180 milliseconds (ms) or the display buffer fullness 544 is less than 50% full. If there is no delay in the video playback and the decoding speed is slow, the lossy decode module 538 may select lossy decode level L2, wherein the video quality at the output frame 536 is moderately worse than that at the reconstruct frame of the encoder. For instance, lossy decode level L2 may be selected if the A/V sync time 542 is less than 160 milliseconds (ms) and the display buffer fullness 544 is less than 30% full. If the video is delayed or there is no video data in the video display buffer, the lossy decode module 538 may select lossy decode level L3, wherein the video quality at the output frame 536 is severely worse than that at the reconstruct frame of the encoder. For instance, lossy decode level L3 may be selected if the A/V sync time 542 is negative (i.e., the video decoding timestamp is less than (or before) the audio decoding timestamp) or the display buffer fullness 544 is 0% full (i.e., the display buffer is empty).

To implement the various lossy decode levels (e.g., lossy decode levels L0-L3), the lossy decode module 538 may cause one or more modifications to one or more components of the video decoder 500. For example, the lossy decode module 538 may selectively modify the operation of the deblock filter 524 and/or the motion compensator 530 to selectively reduce the processing time and complexity required by such components. For lossless decoding (e.g., level L0), the lossy control module 538 may fully enable the deblock filter 524 for all referenced or non-referenced frames, and may enable full-precision fractional motion compensation by the motion compensator 530. For lossy decoding levels (e.g., levels L1-L3), the lossy decode module 538 may disable the deblock filter for one or more types frames, and/or may adjust the strength of the deblock filter for one or more types of frames. Similarly, for lossy decoding levels (e.g., levels L1-L3), the lossy control module 538 may disable motion compensation or may enable low-precision motion compensation by the motion compensator 530 for one or more types of frames.

As an example implementation, for lossy decode level L0 the lossy control module 538 may provide lossless decoding by fully enabling the deblock filter 524 and the motion compensator 530 for all frames. For lossy decode level L1, the lossy control module 538 may weaken or disable the deblock filter 524 for non-referenced frames only and may fully enable the motion compensator 530 to provide full-precision fractional motion compensation. For lossy decode level L2, the lossy control module 538 may weaken or disable the deblock filter 524 for inter-referenced frames and non-referenced frames and may fully enable the motion compensator 530 to provide full-precision fractional motion compensation. For lossy decode level L3, the lossy control module 538 may weaken or disable the deblock filter 524 for all frames may configure the motion compensator 530 to provide low-precision motion compensation for non-referenced frames.

In at least some implementations, the lossy control module 538 may additionally or alternatively utilize other conditions to provide adaptive lossy decoding. For example, the lossy control module 538 may utilize CPU loading information 546 or device battery life 548 in addition to or instead of the conditions discussed above.

When the CPU loading of a device that implements the video decoder 500 is higher than a determined threshold (e.g., 50%, 75%, 95%), the lossy control module 538 may enable lossy decoding (e.g., levels L1, L2 or L3) to release CPU loading to other player modules (e.g., rendering), which may improve the playback experience for the user. As a non-limiting example, when the CPU loading used by the decoder 500 reaches 95%, which means only 5% CPU loading is available for rendering, the lossy control module 538 may trigger lossy decoding (e.g., level L2) to release some of the CPU loading used by the decoder so that video rendering may increase its CPU loading (e.g., from 5% to 10%) to provide smooth playback.

When remaining battery life 548 reaches a low level, the lossy control module 538 may enable lossy decoding to prevent the decoder 500 from draining all of the power from the battery so that the user can have a longer viewing experience. For example, if the remaining battery life 548 is detected to be 10% on a smartphone, the smartphone may shutdown during playback after about 5 minutes. By triggering lossy decoding which substantially reduces computing power required by the decoder, the smartphone would not shut down for an extended period of time (e.g., 10 minutes, 30 minutes), thereby allowing the user to continue watching the content for an extended duration (e.g., until the end of a current episode).

In at least some implementations, the lossy decoding level may be selected based on information about the content, such as the remaining duration of an episode. In such instances, the lossy control module 538 may select more severe lossy levels if there is a significant amount of time (e.g., 30 minutes) remaining in an episode so that the device will not shut down during that amount of time, and may select less severe lossy levels if there is a relatively short amount of time (e.g., 5 minutes) remaining in an episode.

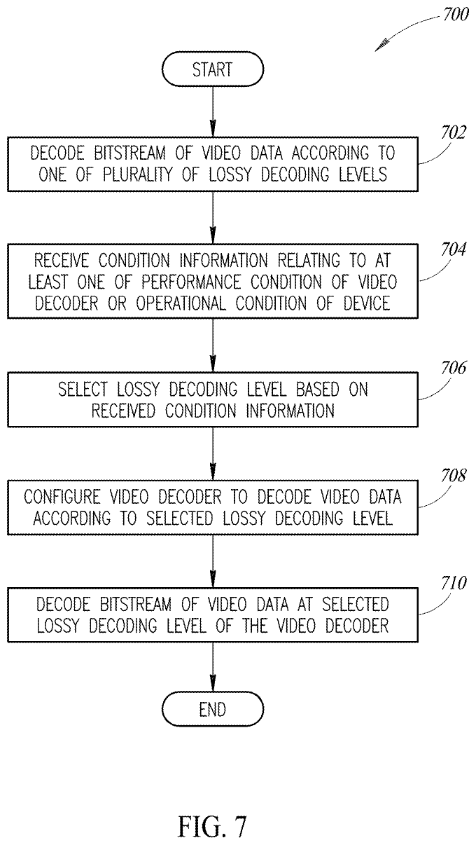

FIG. 7 illustrates a high level flow diagram of a method 700 of operating a video decoder to decode video data with adaptive lossy decoding. The method 700 may be performed by the video decoder devices 300 and 500 discussed above, for example.

At 702, the video decoder decodes a bitstream of video data according to one of a plurality of lossy decoding levels of the video decoder. As discussed above, each of the plurality of lossy decoding levels may provide different levels of performance for the video decoder. For example, each of the lossy decoding levels may provide a different balance of speed and quality, with levels that provide higher speed (and require more computing power) providing lower quality decoding. In at least some implementations, at least one of the plurality of selectable lossy decoding levels provides lossless decoding, such as level L0 discussed above.

In at least some implementations, the plurality of selectable lossy decoding levels includes a first lossy decoding level which provides lossless decoding, a second lossy decoding level in which a deblock filter of the video decoder is weakened or disabled for non-referenced frames only, a third lossy decoding level in which the deblock filter is weakened or disabled for inter-referenced frames and non-referenced frames, and a fourth lossy decoding level in which the deblock filter is weakened or disabled for all frames, and a motion compensator of the video decoder is configured to provide low-precision motion compensation for non-referenced frames. It should be appreciated that the lossy decode levels and their particular configurations may be modified to suit a particular application. For example, in at least some implementations the number of lossy decode levels may be two levels, four levels, eight levels, sixteen levels, etc., each of which providing different combinations of modifications to one or more components of the decoder.

At 704, control circuitry (e.g., lossy control module) of the decoder receives condition information relating to at least one of a performance condition of the video decoder or an operational condition of a device communicatively coupled to the video decoder. In at least some implementations, the condition information includes at least one of a difference between an audio timestamp and a video timestamp of the video data or a buffer fullness level of a video display buffer. In at least some implementations, the condition information includes at least one of CPU loading information or battery life information for a battery of the device that implements the video decoder.

At 706, the control circuitry selects one of the plurality of lossy decoding levels based at least in part on the received condition information. As noted above, under certain conditions, the lossy control module selects a lossy decoding level that provides lower quality decoding but also provides increased decoding speed and reduced processing requirements.

At 708, the control circuitry configures the video decoder to decode video data according to the selected lossy decoding level. For example, the control circuitry may the modify operation of the deblock filter or the motion compensator of the video decoder, as discussed above. To modify the operation of the deblock filter, the control circuitry may at least one of enable the deblock filter for all frames, disable the deblock filter for referenced frames or non-referenced frames, adjust a strength of the deblock filter, or disable the deblock filter. To modify the operation of the motion compensator, the control circuitry may at least one of enable full-precision fractional motion compensation by the motion compensator for some or all frames, enable low-precision motion compensation by the motion compensator for some or all frames, or disable the motion compensator.

At 710, the control circuitry decodes the bitstream of video data at the selected lossy decoding level of the video decoder. The method 700 may be repeated iteratively during playback or rendering of a video. For example, the control circuitry may receive updated condition information periodically (e.g., every second, every two seconds) at regular or irregular intervals, and may adaptively adjust the decoder quality based on the updated conditions of the decode process and/or the conditions of the device that implements the decoder.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A video decoder operative to decode video data, comprising:
at least one nontransitory processor-readable storage medium that stores at least one of processor-executable instructions or data; and
control circuitry communicatively coupled to the at least one nontransitory processor-readable storage medium, in operation, the control circuitry:
decodes a bitstream of video data according to one of a plurality of lossy decoding levels of the video decoder, each of the plurality of lossy decoding levels providing different levels of performance for the video decoder; and
iteratively during decoding of the bitstream of video data,
receives condition information relating to at least one of: a performance condition of the video decoder, or an operational condition of a device communicatively coupled to the video decoder;
selects one of the plurality of lossy decoding levels based at least in part on the received condition information;
configures the video decoder to decode video data according to the selected lossy decoding level; and
decodes the bitstream of video data at the selected lossy decoding level of the video decoder.

2. The video decoder of claim 1 wherein at least one of the plurality of selectable lossy decoding levels provides lossless decoding.

3. The video decoder of claim 1 wherein the video decoder includes a deblock filter, and to configure the video decoder to decode video data according to the selected lossy decoding level, the control circuitry modifies operation of the deblock filter of the video decoder.

4. The video decoder of claim 3 wherein to configure the video decoder to decode video data according to the selected lossy decoding level, the control circuitry at least one of weakens or disables operation of the deblock filter of the video decoder.

5. The video decoder of claim 3 wherein to configure the video decoder to decode video data according to the selected lossy decoding level, the control circuitry at least one of:
enables the deblock filter for all frames;
disables the deblock filter for referenced frames or non-referenced frames;
adjusts a strength of the deblock filter; or
disables the deblock filter.

6. The video decoder of claim 1 wherein the video decoder includes a motion compensator, and to configure the video decoder to decode video data according to the selected lossy decoding level, the control circuitry modifies operation of the motion compensator of the video decoder.

7. The video decoder of claim 6 wherein to configure the video decoder to decode video data according to the selected lossy decoding level, the control circuitry at least one of weakens or disables operation of the motion compensator of the video decoder.

8. The video decoder of claim 7 wherein to configure the video decoder to decode video data according to the selected lossy decoding level, the control circuitry at least one of:
enables full-precision fractional motion compensation by the motion compensator;
enables low-precision motion compensation by the motion compensator; or
disables the motion compensator.

9. The video decoder of claim 1 wherein the video decoder includes a deblock filter and a motion compensator, and to configure the video decoder to decode video data according to the selected lossy decoding level, the control circuitry modifies operation of at least one of the deblock filter or the motion compensator of the video decoder.

10. The video decoder of claim 9 wherein to configure the video decoder to decode video data according to the selected lossy decoding level, the control circuitry at least one of weakens or disables operation of at least one of the deblock filter or the motion compensator of the video decoder.

11. The video decoder of claim 9 wherein the plurality of selectable lossy decoding levels comprises:
a first lossy decoding level which provides lossless decoding;
a second lossy decoding level in which the deblock filter is weakened or disabled for non-referenced frames only;
a third lossy decoding level in which the deblock filter is weakened or disabled for inter-referenced frames and non-referenced frames; and
a fourth lossy decoding level in which the deblock filter is weakened or disabled for all frames, and the motion compensator is configured to provide low-precision motion compensation for non-referenced frames.

12. The video decoder of claim 1 wherein the received condition information comprises at least one of a difference between an audio timestamp and a video timestamp of the video data, or a buffer fullness level of a video display buffer.

13. The video decoder of claim 1 wherein the received condition information comprises at least one of: CPU loading information or battery life information for a battery of the device communicatively coupled to the video decoder.

14. A video decoding method to decode video data, the method comprising:
decoding a bitstream of video data according to one of a plurality of lossy decoding levels of a video decoder, each of the plurality of lossy decoding levels providing different levels of performance for the video decoder; and
iteratively during decoding of the bitstream of video data,
receiving condition information relating to at least one of: a performance condition of the video decoder, or an operational condition of a device communicatively coupled to the video decoder;
selecting one of the plurality of lossy decoding levels based at least in part on the received condition information;
configuring the video decoder to decode video data according to the selected lossy decoding level; and
decoding the bitstream of video data at the selected lossy decoding level of the video decoder.

15. The video decoding method of claim 14 wherein selecting one of the plurality of lossy decoding levels comprises selecting one of the plurality of lossy decoding levels, at least one of which provides lossless decoding.

16. The video decoding method of claim 14 wherein the video decoder includes a deblock filter, configuring the video decoder to decode video data according to the selected lossy decoding level comprises modifying operation of the deblock filter of the video decoder.

17. The video decoding method of claim 16 wherein configuring the video decoder to decode video data according to the selected lossy decoding level comprises at least one of weakening or disabling operation of the deblock filter of the video decoder.

18. The video decoding method of claim 16 configuring the video decoder to decode video data according to the selected lossy decoding level comprises at least one of:
enabling the deblock filter for all frames;
disabling the deblock filter for referenced frames or non-referenced frames;
adjusting a strength of the deblock filter; or
disabling the deblock filter.

19. The video decoding method of claim 14 wherein the video decoder includes a motion compensator, and configuring the video decoder to decode video data according to the selected lossy decoding level comprises modifying operation of the motion compensator of the video decoder.

20. The video decoding method of claim 19 wherein configuring the video decoder to decode video data according to the selected lossy decoding level comprises at least one of weakening or disabling operation of the motion compensator of the video decoder.

21. The video decoding method of claim 20 wherein configuring the video decoder to decode video data according to the selected lossy decoding level comprises at least one of:
enabling full-precision fractional motion compensation by the motion compensator;
enabling low-precision motion compensation by the motion compensator; or
disabling the motion compensator.

22. The video decoding method of claim 14 wherein the video decoder includes a deblock filter and a motion compensator, and configuring the video decoder to decode video data according to the selected lossy decoding level comprises modifying operation of at least one of the deblock filter or the motion compensator of the video decoder.

23. The video decoding method of claim 22 wherein configuring the video decoder to decode video data according to the selected lossy decoding level comprises at least one of weakening or disabling operation of at least one of the deblock filter or the motion compensator of the video decoder.

24. The video decoding method of claim 22 wherein selecting one of the plurality of lossy decoding levels comprises selecting one of:
a first lossy decoding level which provides lossless decoding;
a second lossy decoding level in which the deblock filter is weakened or disabled for non-referenced frames only;
a third lossy decoding level in which the deblock filter is weakened or disabled for inter-referenced frames and non-referenced frames; and
a fourth lossy decoding level in which the deblock filter is weakened or disabled for all frames, and the motion compensator is configured to provide low-precision motion compensation for non-referenced frames.

25. The video decoding method of claim 14 wherein receiving condition information comprises receiving at least one of a difference between an audio timestamp and a video timestamp of the video data, or a buffer fullness level of a video display buffer.

26. The video decoding method of claim 14 wherein receiving condition information comprises receiving at least one of: CPU loading information or battery life information for a battery of the device communicatively coupled to the video decoder.
